(19) United States
(12) Patent Application Publication
(10) Pub. No.: US 2020/0278002 A1
(43) Pub. Date: Sep. 3, 2020

(54) Brake Dust Particle Filter and Disc Brake Assembly Comprising a Brake Dust Particle Filter

(71) Applicant: MANN+HUMMEL GmbH, Ludwigsburg (DE)

(72) Inventors: Lukas Bock, Bietigheim-Bissingen (DE); Thomas Jessberger, Asperg (DE); Volker Kuemmerling, Bietigheim-Bissingen (DE); Robert Zbiral, Marbach (DE); Coskun Evlekli, Waiblingen (DE)

(21) Appl. No.: 16/811,252

(22) Filed: Mar. 6, 2020

Related U.S. Application Data
(63) Continuation of application No. PCT/EP2018/073600, filed on Sep. 3, 2018.

(30) Foreign Application Priority Data
Sep. 8, 2017 (DE) 10 2017 008 421.1

(51) Int. Cl. F16D 65/00; F16D 55/22; B01D 46/10; B01D 46/00

(52) U.S. Cl. CPC F16D 65/0031; F16D 55/22; F16D 2055/0037; B01D 46/0046; B01D 46/0002; B01D 46/106

(57) ABSTRACT

A brake dust particle filter, for catching particles produced when braking, for a disc brake assembly with a brake disc and a brake caliper has a ring segment-shaped housing with a housing interior that accommodates the brake disc. The housing has two housing sidewalls that are axially spaced apart and a housing peripheral wall extending radially outwardly in a circumferential direction of the housing. The housing peripheral wall is arranged between the two housing sidewalls. At least one tongue projects with at least one radial component from the housing peripheral wall into the housing interior. The tongue has a flat cross-sectional shape and at least one base surface facing the housing peripheral wall, a cover surface projecting into the housing interior, and at least one side surface. The tongue supports a filter medium and is covered at least at the at least one side surface with the filter medium.

### CROSS-REFERENCE TO RELATED APPLICATIONS

This application is a continuation application of international application No. PCT/EP2018/073600 having an international filing date of 3 Sep. 2018 and designating the United States, the international application claiming a priority date of 8 Sep. 2017 based on prior filed German patent application No. 10 2017 008 421.1, the entire contents of the aforesaid international application and the aforesaid German patent application being incorporated herein by reference.

### BACKGROUND OF THE INVENTION

The invention concerns a brake dust filter for a disc brake assembly with a brake disc and a brake caliper. The brake dust particle filter is configured for catching particles that are produced when braking. The invention concerns moreover a disc brake assembly with such a brake dust particle filter.

It is known to catch and dispose of particles that are produced by brake abrasion by means of a brake dust particle filter. Such particles are produced by friction between brake pad and brake disc of a disc brake. Such a brake dust particle filter has become known, for example, from DE 10 2012 016 835 A1. This brake dust particle filter however requires an integration in a brake caliper housing and is suitable therefore only to a limited extent as a retrofitting solution.

### SUMMARY OF THE INVENTION

In contrast to this, it is the object of the present invention to provide a brake dust particle filter that is configured to be more efficient for separating particles that are produced when braking as well as suitable for retrofitting of existing vehicles. Object of the present invention is furthermore to provide a disc brake assembly with such a brake dust particle filter.

The brake dust particle filter according to the invention is suitable for any applications of disc brakes, mobile as well as stationary applications. In mobile applications, it can be employed, for example, in passenger cars, trucks, buses rail vehicles. Stationary applications, for example, concern shaft brakes as they are used in wind power devices.

The object is solved by a brake dust particle filter of the aforementioned kind that comprises:
a ring segment-shaped housing for at least partial accommodation of the brake disc in a housing interior, wherein the housing comprises two housing sidewalls that are axially spaced apart from each other and a housing peripheral wall extending radially outwardly in circumferential direction, and wherein the housing peripheral wall is arranged or embodied between the housing sidewalls;
at least one tongue in the housing interior projecting at least in sections with at least one radial component from the housing peripheral wall inwardly;
wherein the tongue comprises a flat cross-sectional shape and at least one base surface which is facing the housing peripheral wall, a cover surface projecting into the housing interior as well as at least one side surface; and
at least one filter medium;

wherein the tongue supports the filter medium and is covered at least at the at least one side surface, in particular completely, with the filter medium.

The object is further solved by a disc brake assembly comprising the brake dust particle filter as claimed.

The dependent claims provide preferred further embodiments.

The brake dust particle filter comprises a ring segment-shaped, approximately banana-shaped and/or helmet-shaped housing. In the housing, the brake disc of a disc brake assembly is received in a mounted state. The housing comprises at least two housing sidewalls and a housing peripheral wall. The housing peripheral wall connects in the mounted state of the brake dust particle filter the two housing sidewalls directly or indirectly. In the interior of the housing, i.e., facing the brake disc, the brake dust particle filter comprises a filter medium. In order to enlarge the effective filter surface of the filter medium, a tongue that supports the filter medium is provided in the brake dust particle filter. According to the invention, the tongue extends at least in sections thereof with at least one radial component away from the housing peripheral wall in a housing interior. The tongue according to the invention has a flat cross-sectional shape and comprises a base surface which is facing the housing peripheral wall, a cover surface projecting into the housing interior as well as at least one side surface. Flat is to be understood herein as a cross-sectional shape whose wide side is much larger than its narrow side. Alternatively, such a cross-sectional shape could also be referred to as flattened or elongate.

The tongue is covered with the filter medium at least partially, namely at least at its side surface, preferably as much as possible, particularly preferred completely. In this way, a higher filtering effect than in the prior art is achieved. The tongue extends in this context preferably from an outer circumference to an inner circumference, i.e., radially inwardly.

In a preferred embodiment, the tongue can have a substantially rectangular cross section wherein a ratio of a wide side to a narrow side of the rectangular cross section is between 15 and 60, preferably between 20 and 40. Such values can be realized for a plurality of sizes of the brake dust particle filter by use of sheet metal plates in standard thicknesses for producing the at least one tongue; for example, sheet metal plates with a thickness (=narrow side of the cross section) between 0.5 and 4 mm can be employed.

In this context, it is not mandatory that the tongue forms a continuous body free of interruptions; instead, it can also be slotted once or multiple times, wherein generally a sufficient support function for the filter medium results even for a slotted tongue. In case of such slotted tongues, the aforementioned ratio specifications refer respectively to an outer contour of the respective tongue and not to the “partial tongues” that are produced by slotting. The tongue can be advantageously made of a mesh material, for example, a metal mesh.

Particularly preferred, the at least one tongue extends in such a way into the interior that its base surface in a mounted state of the brake dust particle filter extends parallel to an axis of rotation of the brake disc.

The tongue can be arranged or embodied at a housing wall, e.g., as one piece together with the housing wall. Preferably, the tongue is arranged or embodied at the housing peripheral wall. Alternatively or additionally, the brake dust particle filter can comprise a filter element, wherein the filter element comprises a filter element support structure on which or at which the filter medium is arranged. In this context, the filter element support structure can comprise the tongue. When providing a filter element, the filter medium is exchangeable particularly easily and environmentally friendly because only the filter element must be exchanged when the filter medium is loaded and not the complete housing. According to this embodiment, a receiving region is advantageously provided for receiving the filter element into which the filter element can be inserted. It can be held, for example, by clips or other fastening elements that appear suitable, in the receiving region. Particularly advantageously, the filter element has a curved shape, in particular a circular arc shape, which corresponds with the inner shape or the radius of the housing peripheral wall.

The filter medium can be fastened indirectly or directly at the tongue, at the housing wall, in particular at the housing peripheral wall, and/or at the filter element support structure. The filter medium can form a fold into which the tongue at least partially extends. In this way, the brake dust particle filter can be produced in a particularly simple way.

According to a further preferred embodiment, at least one additional tongue is provided that projects from at least one housing sidewall into the housing interior. Preferably, the tongue projecting from the housing peripheral wall and the tongue projecting from the housing sidewall form a continuous tongue which comprises an L-shaped or U-shaped basic form. In this way, the effective tongue surface is greatly increased which contributes to an even more improved separation performance. Moreover, in this way a configuration that saves space in radial direction is possible because a portion of the entire tongue surface can be distributed onto the tongue which is provided at the housing sidewall.

The tongue can comprise at least one through opening which is covered by the filter medium. In this way, the filter medium can be flowed through in the region of the tongue. The tongue can advantageously comprise also a plurality of through openings which are each covered by the filter medium.

In a further preferred embodiment of the invention, in the region of the tongue the filter medium is embodied in the form of a collecting pocket or catching pocket for particles wherein the catching pocket is closed in downward direction so that particles cannot fall out of the catching pocket due to the gravity acting on them. The brake dust particle filter can retain in this way large particle quantities. The shape of the collecting or catching pocket can advantageously be imparted to the filter medium by the at least one tongue which has just such a shape. Preferably, a lowest point of the pocket is pointing downwardly in the direction of gravity.

In a further preferred embodiment of the brake dust particle filter, the filter medium comprises at least a first filter layer with a porosity and a second filter layer with a larger porosity. The two filter layers can be embodied in the form of regions (viewed in the direction of thickness) of the filter medium so that the filter medium has a porosity gradient. Alternatively or additionally thereto, an additional filter medium can be provided on the filter medium, wherein the porosity of the additional filter medium differs preferably from the porosity of the filter medium. Due to this arrangement or configuration of different filter layers, the degree of separation of the brake dust particle filter can be matched precisely to the respective application. Advantageously, the pore size in this context decreases in radial direction from the interior to the exterior.

The brake dust particle filter can comprise in addition to the afore described tongue at least one additional tongue in the housing interior. In other words, the brake dust particle filter comprises preferably a plurality of tongues that are projecting inwardly in the housing interior and are preferably arranged spaced apart in circumferential direction. The tongues support the filter medium and are covered at least partially, in particular completely, by the filter medium. By the arrangement or configuration of a plurality of tongues, the filter action is further significantly increased. At least two tongues can be positioned in this context at a different angle relative to the housing peripheral wall, respectively. Angle relative to the housing peripheral wall is understood here as an angle between a tangent, placed at an imaginary contact point of the tongue at the housing peripheral wall, and the length extension of the tongue.

The brake dust particle filter is preferably designed such that the filtering action increases in circumferential direction of the housing. The increase is realized in this context preferably away from a bearing region of the housing, wherein the bearing region is provided for bearing against the brake caliper of the disc brake assembly. In other words, the brake dust particle filter is preferably embodied such that the filter action increases with increasing distance from the brake caliper or from the bearing region for bearing against the brake caliper. A better filter action is understood herein, for example, as the ability of separating finer particle fractions. This is realized in particular by one or a plurality of the following measures:
The porosity of the filter medium decreases in circumferential direction of the housing. In particular, the filter medium comprises a larger porosity at a tongue than the filter medium at the next neighboring tongue which is located farther away from the bearing region of the brake dust particle filter.
The thickness of the filter medium increases in circumferential direction of the housing.
A tongue is positioned at a smaller angle relative to the housing peripheral wall than a neighboring tongue that is located farther away from the bearing region.
A tongue comprises more and/or larger through openings than a neighboring tongue which is located farther away from the bearing region of the brake dust particle filter, wherein preferably the dimensions of the through openings decrease in circumferential direction away from the bearing region.
A tongue with its free end projects less far into the interior of the housing than a neighboring tongue that is located farther away from the bearing region of the brake dust particle filter.
The surface of a tongue is smaller than the surface of a neighboring tongue that is located farther away from the bearing region of the brake dust particle filter.

The brake dust particle filter can comprise at least one opening for the discharge of filtered air in the housing wall, in particular in the housing peripheral wall. Preferably, the brake dust particle filter comprises a plurality of openings for the discharge of filtered air in the housing wall, in particular in the housing peripheral wall.

At least one opening is provided preferably in a housing end region which—viewed in circumferential direction of the housing—is embodied in the region of the brake caliper. The housing end region bridges preferably at least one radially outwardly open region of the brake caliper because, there, a high brake dust discharge occurs typically that, in addition to the brake abrasion that leaves the brake caliper in tangential direction, constitutes the greatest emission source. Preferably, the filter medium is a continuous material strip which extends across the plurality of inwardly positioned tongues as well as across the inner side of the housing peripheral wall in the housing end region.

In order to prevent that air is pressed by the back pressure during driving against the filtration direction through the filter medium, at least one outwardly projecting rib is arranged or embodied at the housing wall, in particular at the housing peripheral wall. Preferably, a plurality of outwardly projecting ribs are provided at the housing wall, in particular at the housing peripheral wall. The at least one outwardly projecting rib can be provided preferably in the region of the at least one opening so that the rib covers the respective opening in the traveling direction at least partially so that a dynamic pressure produced by driving does not act on the opening. Preferably, a plurality of outwardly projecting ribs are provided respectively in the region of an opening for discharge of filtered air, preferably each one of the openings is provided with an afore described rib.

The filter medium is preferably configured such that, even at a temperature of more than 600° C., it is stable in order to withstand the temperatures in immediate environment of a disc brake. In this context, the filter medium can comprise a metal, metal fiber nonwoven, glass, ceramic and/or a high temperature-resistant plastic material, in particular polyether ether ketone. However, the housing should comprise also advantageously a sufficient temperature resistance; for this purpose, it can be embodied of sheet metal, preferably sheet steel. In addition to the excellent temperature resistance, sheet steel has the further advantage that the housing can be obtained by a simple deformation process, for example, by deep drawing.

The ring segment-shaped housing covers preferably a large angle range of the brake disc in order to obtain a high filtration action. The housing extends in this context preferably about a ring segment angle of more than 45°, in particular of more than 75°, particularly preferred of more than 90°. When selecting a suitable enclosing angle, there is a conflict of objectives to be solved between the proportion of particles to be filtered and the cooling performance that can be made available to the disc brake.

For facilitating mounting of the housing, the housing can have a first and a second housing part. The two housing parts preferably can be arranged at least partially axially at both sides of the brake disc. Particularly preferred, the first housing part and the second housing part can be connected in a reversibly detachable way. Alternatively, the two housing parts can also be connected non-detachably, for example, welded. Advantageously, according to this embodiment, the filter medium is inserted already prior to connecting the housing parts so that at least the pre-assembly process is simplified, even though the exchange of the filter medium in service is not. In this case, it is however conceivable to exchange in the service situation the entire brake dust filter (including housing+filter medium) in order to subject it to refurbishing, for example. As an alternative to welding, it can be provided that the first housing part and the second housing part are connected to each other by a crimped connection.

For connecting the two housing parts, a screw connection, a clip connection, a folding mechanism and/or a pivot mechanism can be provided.

The housing peripheral wall can be part of the first housing part or of the second housing part so that it is connected with one of the two housing sidewalls. The housing peripheral wall can be embodied moreover at least partially of housing parts that are overlapping each other.

Particularly preferred, the first housing part comprises the at least one inwardly projecting tongue and the second housing part comprises at least one opening. Further preferred, all inwardly projecting tongues are provided at the first housing part and all openings at the second housing part. The separate configuration of tongue(s) and opening(s) facilitates significantly the production of the brake dust particle filter because the openings, optionally with corresponding ribs, as well as the inwardly positioned tongues can be produced by punching.

A housing part can be pivotable relative to an additional housing part that remains stationary. The pivot axis of such a pivot mechanism can extend parallel to an axis connecting the two housing sidewalls, in particular parallel to the axis of rotation of the brake disc. Particularly preferred, the housing part that comprises the housing peripheral wall is pivotable at least partially relative to the further housing in this case. Alternatively or additionally to this, the pivot axis can extend in the radial direction of the housing or relative to the brake disc, i.e., normal to the axis of rotation of the brake disc. In this case, a first housing sidewall is preferably pivotable relative to the further housing.

The afore described pivoting ability simplifies significantly an exchange of the filter medium in the service situation.

The object according to the invention is furthermore solved by a disc brake assembly with a brake disc, a brake caliper, and a brake dust particle filter as described above.

The brake dust particle filter can have a stationary position relative to the brake caliper, a wheel bearing housing and/or a splash guard. Alternatively or additionally thereto, the brake dust particle filter can be fastened to the brake caliper, to a wheel bearing housing and/or to a splash guard, wherein an attachment at the brake caliper can be advantageously provided when a so-called stationary caliper is concerned. Particularly advantageously, the brake dust particle filter can be connected to the wheel bearing housing at the same fastening points as the brake caliper. Moreover, the screws with which the brake caliper is screwed to the wheel bearing housing can comprise at least in the region of a screw head a blind bore thread so that the brake dust particle filter is connectable with the screws so that advantageously the safety-critical screw connection of the brake caliper (holder) with the wheel bearing housing is not affected (settling/pretension force change).

In a particularly preferred embodiment of the invention, one housing part of the brake dust particle filter can be a splash guard element, in particular splash guard plate, that, positioned inwardly, covers the brake disc at least partially. In this way, an additional splash guard plate is not required so that weight can be saved, which provides driving-dynamic advantages as a result of an arrangement in the unsprung region of a chassis.

In order to effect a particularly effective particle separation, the brake dust particle filter is preferably arranged so as to immediately adjoin the brake caliper. The brake dust particle filter in this context is arranged preferably downstream of the brake caliper, wherein in this context the term “downstream” relates to the rotational direction of the brake disc for an intended forward travel of the vehicle at which the disc brake assembly is provided.

The brake dust particle filter covers preferably at least partially an outer side of the brake caliper, particularly preferred a circumferential outer side of the brake caliper. The coverage of the brake caliper is realized preferably with the housing end region. Particularly preferred, the brake caliper is covered completely in the region of the circumferential outer side, at which often openings for cooling air supply and/or service (removal of the friction pads) are located, at least however in the region of the openings, by the housing end region of the brake dust particle filter so that no unfiltered outflow occurs in this region, but particle-laden air that exits from there first flows through the filter medium and subsequently through the opening in the housing peripheral wall into the environment.

In a further preferred embodiment of the disc brake assembly, the at least one inwardly projecting tongue with its free end is oriented toward the brake caliper. Preferably, a plurality, in particular all, tongues are oriented with their respective free ends toward the brake caliper. In this way, the filter efficiency can be further increased because brake dust particles that are entrained tangentially by the rotation essentially can all be caught by the shape of the tongues.

Further features and advantages of the invention result from the following description of several embodiments of the invention, from the claims as well as the Figures which show invention-relevant details. The features illustrated in the Figures are illustrated such that the particularities of the invention can be made visible clearly. The different features can be realized individually or several thereof combined in any combinations in variants of the invention and are therefore combinable with each other.

### BRIEF DESCRIPTION OF THE DRAWINGS

FIG. 1 shows a side view of a disc brake assembly according to the invention with a first embodiment of the brake dust particle filter.

FIG. 2 shows a cross section of the brake dust particle filter according to FIG. 1.

FIG. 3 is an isometric view of the brake dust particle filter according to FIG. 1.

FIG. 4 is an isometric view of a first housing part and of a second housing part of the housing of a brake dust particle filter in a second embodiment of the disc brake assembly.

FIG. 5 is an isometric view of the first housing part of the housing of the brake dust particle filter of a third embodiment of the disc brake assembly with inwardly projecting tongues and a second housing part with openings and outwardly projecting ribs.

FIG. 6 is an isometric view of the connection of a first housing part and of a second housing part of a fourth embodiment of the disc brake assembly by a pivot mechanism and/or a folding mechanism.

FIG. 7 is an isometric view of the connection of the first housing part and of the second housing part by a pivot mechanism and/or a folding mechanism along a further pivot axis in a fifth embodiment of the disc brake assembly.

FIG. 8 is an isometric view of a brake dust particle filter according to a further embodiment with tongues at a housing peripheral wall as well as at a housing sidewall.

### DESCRIPTION OF PREFERRED EMBODIMENTS

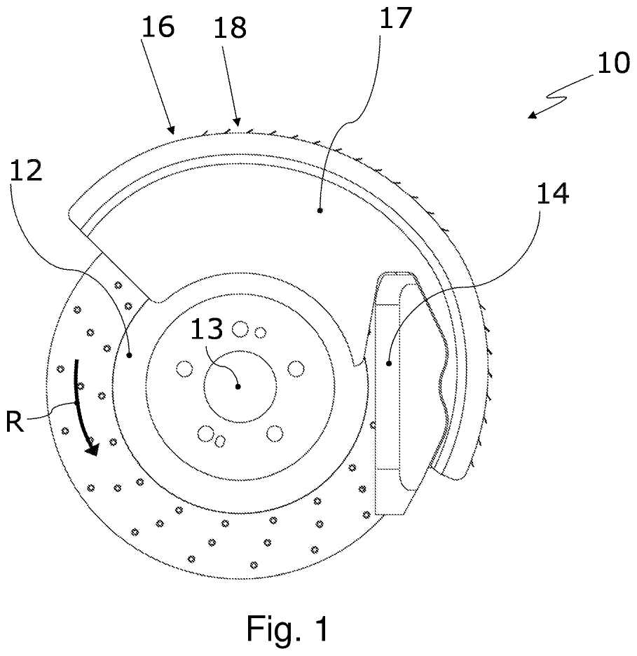

FIG. 1 shows a side view of a disc brake assembly 10 with a disc brake 12 which comprises an axis of rotation or rotary axis 13, with a brake caliper 14 and a brake dust particle filter 16 in a first embodiment. In this context, the brake dust particle filter 16 is stationarily arranged in its position relative to the brake caliper 14 and/or attached to the brake caliper 14. The disc brake assembly 10 comprises moreover a wheel bearing housing (not illustrated) to which the brake caliper 14 is fastened, and the brake dust particle filter 16 can be stationarily arranged in its position relative to the wheel bearing housing and/or fastened to the wheel bearing housing. Alternatively or additionally thereto, the disc brake assembly 10 can comprise a splash guard (not illustrated) in the form of a splash guard plate, and the brake dust particle filter 16 can be arranged stationarily in its position relative to the splash guard and/or can be fastened to the splash guard.

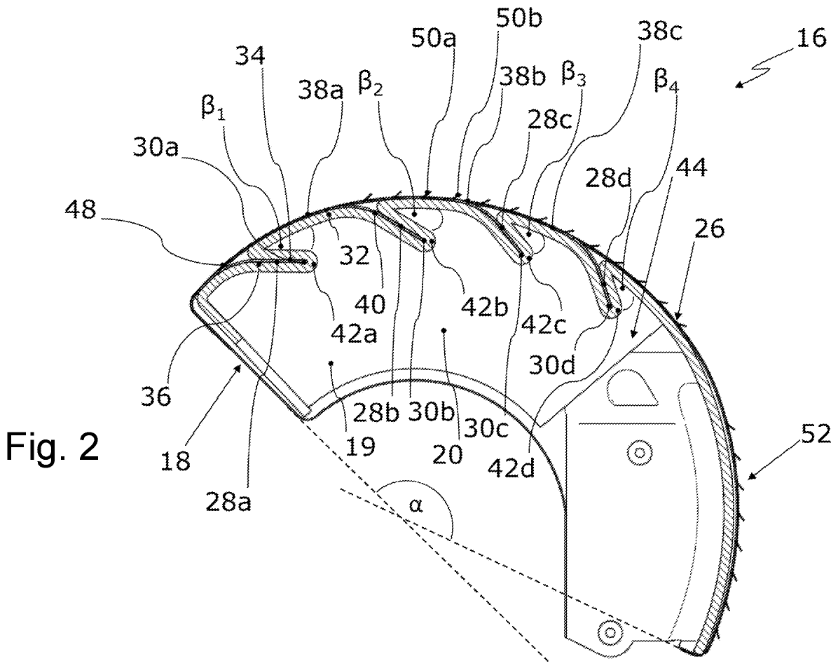

The brake dust particle filter 16 comprises a first housing sidewall 17 which forms a part of a ring segment-shaped housing 18. A second housing sidewall 19 (see FIG. 2) is arranged, spaced apart axially along the rotary axis 13 of the brake disc 12, relative to the first housing sidewall 17 and also forms a part of the ring segment-shaped housing 18, and between them the brake disc 12 is received in the housing interior 20.

The brake dust particle filter 16 can be arranged downstream of the brake caliper 14, in particular in rotation direction R of the brake disc 12 upon forward travel of a vehicle at which the disc brake assembly 10 can be arranged.

In FIG. 2, a cross section of the brake dust particle filter 16 for filtering air that is provided with brake dust is illustrated. By means of the ring segment-shaped housing 18, the brake dust particle filter 16 can accommodate the brake disc 12 (see FIG. 1) at least partially in the housing interior 20. The ring segment-shaped housing 18 can extend about a ring segment angle α of more than 90° in this embodiment. The brake dust particle filter 16 is arranged flush at the brake caliper 14 (see FIG. 1) so that, when braking, air moved by the brake disc 12 (see FIG. 1) can flow from the brake caliper 14 into the brake dust particle filter 16.

The housing 18 comprises a housing peripheral wall 26 which extends radially outwardly in circumferential direction of the brake dust particle filter 16. The housing sidewalls 17 (see FIG. 1), 19 are connected to each other by the housing peripheral wall 26.

The brake dust particle filter 16 comprises moreover tongues 28a, 28b, 28c, 28d. These tongues 28a-28d are arranged at the housing peripheral wall 26 of the brake dust particle filter 16 or embodied as in FIG. 2. They project in the housing interior 20 of the brake dust particle filter 16 from the housing peripheral wall 26 inwardly. In this context, they are positioned relative to the housing peripheral wall 26 at an angle β₁, β₂, β₃, β₄, respectively. At these tongues 28a-28d, the air which flows into the brake dust particle filter 16 can be guided in the direction toward the housing peripheral wall 26. The tongues 28a-28d are oriented with their respective free ends 30a, 30b, 30c, 30d toward the brake caliper 14 (see FIG. 1).

A filter medium 32 for cleaning the air from particles is arranged at the tongues 28a-28d and covers the tongues 28a-28d. The filter medium 32 extends across the side of the respective tongue 28a-28d which is facing the housing peripheral wall 26 as well as across the side which is facing away from the housing peripheral wall 26 so that the tongues 28a-28d are covered by the filter medium 32, respectively. The filter medium is a continuous material strip which extends across all tongues 28a-28d as well as across the inner side of the housing peripheral wall 26 in the housing end region 52.

In an exemplary fashion, the facing side is here identified at the tongue 28a by 34 and the side that is facing away by 36. The effective filter surface is thus enlarged by the tongues 28a-28d in circumferential direction of the housing interior 20. The filter medium 32 is moreover arranged at the sections 38a, 38b, 38c of the housing peripheral wall 26 between the tongues 28a-28d. In this way, the filter medium 32 is connected immediately to the housing peripheral wall 26. In particular, it is attached to the housing peripheral wall 26 and/or to the tongues 28a-28d. Alternatively, it can be connected also indirectly to the wall of the housing 18 by means of further intermediate layers. The tongues 28a-28d can comprise one or a plurality of through openings (not shown) which are covered by the filter medium 32.

The tongues 28a-28d form a support structure 40 for the filter medium 32. For this purpose, the tongues 28a-28d project into folds 42a, 42b, 42c, 42d of the filter medium 32.

The filter medium 32 can comprise at least a first region and a second region (not shown). The first region can be embodied between the respective tongues 28a-28d and the second region. In this context, for coarse filtration the first region can comprise a larger porosity than the second region. The filter medium in addition can also comprise a third and/or further such regions of different porosities. As an alternative thereto, the transition from a larger porosity of the filter medium to a smaller porosity in the direction of the tongue 28a-28d can also be continuously realized (gradient).

In a further embodiment, the brake dust particle filter comprises, in addition to the filter medium 32, an additional filter medium (not illustrated). In this context, the filter medium 32 is arranged between the respective tongue 28a-28d and the additional filter medium. The additional filter medium comprises a larger porosity than the first filter medium. In an alternative embodiment, the brake dust particle filter 16 can comprise additional filter media with different porosity.

The brake dust particle filter 16 can be designed such that the filter action on the air moved in the circumferential direction by the brake disc 12 increases. For this purpose, the porosity of the filter medium 32 can decrease in circumferential direction of the housing, beginning at a bearing region 44 of the brake dust particle filter 16 provided for bearing against the brake caliper 14 (see FIG. 1). Alternatively or in addition thereto, the thickness of the filter medium 32 can increase in the circumferential direction of the housing 18, beginning at the bearing region 44 of the brake dust particle filter 16 provided for bearing against the brake caliper 14 (see FIG. 1). Alternatively or additionally thereto, a tongue 28a-28d can be positioned at a smaller angle β₁, β₂, β₃, β₄ relative to the housing peripheral wall 26 than a neighboring tongue 28a-28d which is located farther away from the aforementioned bearing region 44. Alternatively or additionally thereto, the free end 30a-30d of a tongue 28a-28d can project less far radially inwardly into the interior 20 of the housing 18 than a neighboring tongue 28a-28d which is located farther away from this bearing region 44. Alternatively or additionally thereto, the surface of at least one tongue 28a-28d that projects into the housing interior 20 can be smaller than the surface of a neighboring tongue 28a-28d which projects into the housing interior 20 and which is farther removed from this bearing region 44.

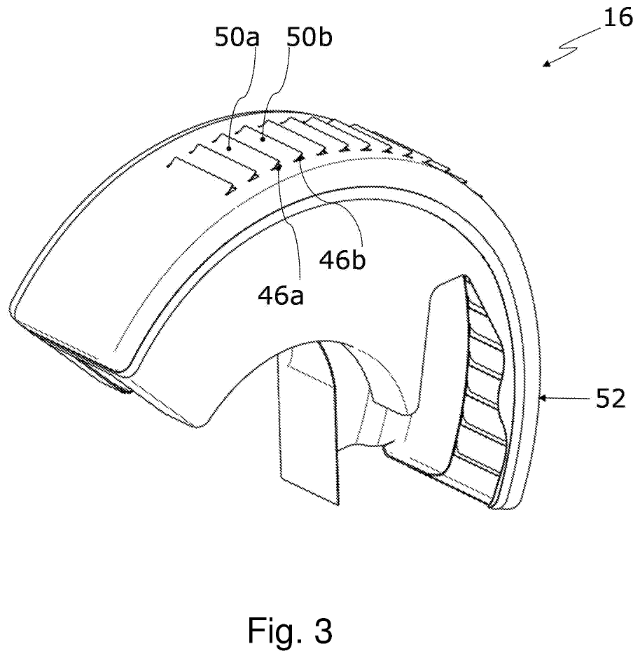

The brake dust particle filter 16 comprises in its housing peripheral wall 26 openings 46a, 46b (see FIG. 3). Through these openings 46a, 46b the purified air can escape to the exterior space. A part of the openings 46a, 46b is completely covered by the tongues 28a-28d covered by the filter medium 32 in the direction away from the housing interior 20 perpendicular to the circumferential direction of the brake dust particle filter 16. Another part of the openings 46a, 46b is covered only by the filter medium 32. In this way, it is ensured that as a whole only purified air can escape through the openings 46a, 46b to the exterior space.

Moreover, ribs are arranged and/or embodied outward at the housing peripheral wall 26 at the exterior side 48 and two of them are identified in an exemplary fashion by 50a, 50b. The ribs 50a, 50b are arranged at the openings 46a, 46b so that the air that escapes outwardly is guided by the ribs 50a, 50b in a desired direction. The ribs 50a, 50b prevent a flow through the filter medium from the clean side to the raw side by a dynamic pressure that is generated by the travel speed.

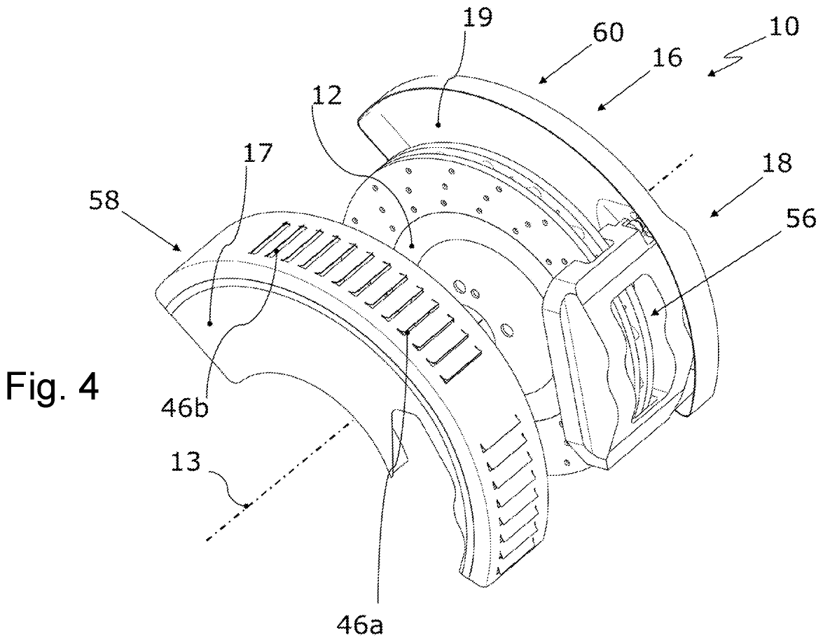

The brake dust particle filter 16 comprises a housing end region 52. The housing end region 52 can comprise at least partially the housing sidewalls 17, 19 and the housing peripheral wall 26. Also, it comprises the filter medium 32 arranged at the housing peripheral wall 26. Outwardly projecting ribs 50a, 50b and openings 46a, 46b in the housing peripheral wall 26 at the ribs 50a, 50b are also arranged and/or embodied in the housing end region 52. The housing peripheral wall 26 extends into the housing end region 52. The housing end region 52 covers in circumferential direction of the brake dust particle filter 16, beginning at the radial outer side of the brake dust particle filter 16, the brake caliper 14, in particular a gap 56 of the brake caliper 14 (see FIG. 4). The housing end region 52 comprises for this purpose a cutout which can be matched to the respective shape of the brake caliper, here a brake caliper with at least two pistons.

FIG. 3 shows an isometric view of the brake dust particle filter 16. In particular, the outwardly oriented ribs 50a, 50b as well as the openings 46a, 46b can be seen. The housing 18 can be embodied as one part, i.e., one piece.

As illustrated in FIG. 4, the housing 18 of the brake dust particle filter 16 in a second embodiment of the disc brake assembly 10 can comprise a first housing part 58 and a second housing part 60. The first housing part 58 comprises in this context the first housing sidewall 17. The second housing part 60 comprises the second housing sidewall 19 which is axially displaced relative to the first housing sidewall 17. Thus, the first housing sidewall 17 can be arranged axially displaced along the rotary axis 13 of the brake disc 12 relative to the brake disc 12, and the second housing sidewall 19 can be arranged at the side of the brake disc 12 facing away from the first housing sidewall 17. The first housing part 58 comprises openings 46a, 46b. The second housing part 60, in particular the second housing sidewall 19, can be embodied in the form of a splash guard plate so that, in case of doubt, a separate splash guard plate of the brake disc can be omitted, which is in particular of interest for OE applications.

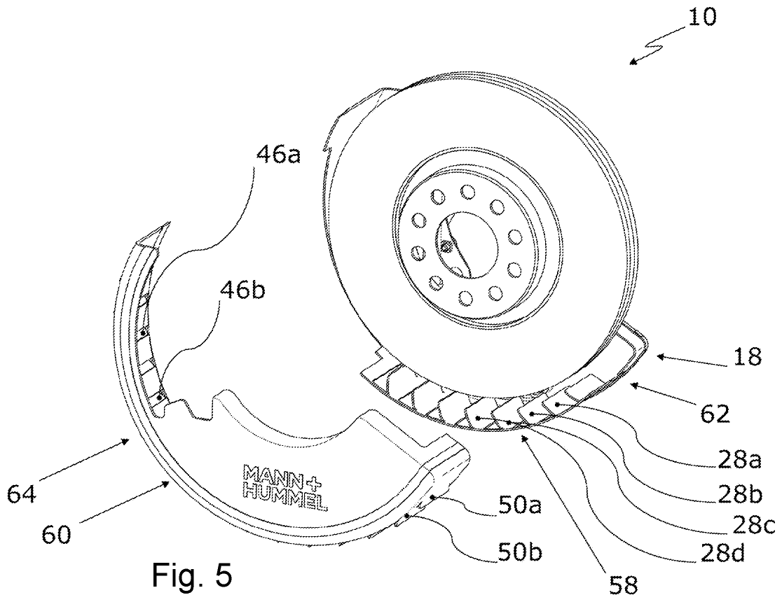

As illustrated in FIG. 5, in a third embodiment of the disc brake assembly 10 the first housing part 58 of the housing 18 can comprise the inwardly projecting tongues 28a-28d. The second housing part 60 can comprise the openings 46a, 46b and the outwardly oriented ribs 50a, 50b. The inwardly projecting tongues 28a-28d can be formed by punching out of the housing peripheral wall 62 of the first housing part 58. The outwardly projecting ribs 50a, 50b can be embodied together with the openings 46a, 46b by punching out the ribs 50a, 50b out of the housing peripheral wall 64 of the second housing part 60. Punching out the ribs 50a, 50b and the tongues 28a-28d in circumferential direction of the brake dust particle filter 16 in the mounted state at the respective housing peripheral wall 62, 64 can be realized for each pair of associated tongues 28a-28d and ribs 50a, 50b at the same location. Then by pushing on the first housing part 58 onto the second housing part 60 it can be ensured in a simple way that the openings 46a, 46b are formed at the correct locations between a respective tongue 28a-28d and rib 50a, 50b, i.e., the openings 46a, 46b are positioned with precise fit above the intermediate spaces between the respective neighboring tongues 28a-28d.

The first housing part 58 and the second housing part 60 can be connected to each other. In particular, they are connectable reversibly to each other in order to be able to perform servicing work quickly. This connection can be realized inter alia by a screw connection of the brake dust particle filter. For this purpose, a housing part 58, 60 can comprise a thread at its outer side and the other housing part 58, 60 a thread at its inner side such that one housing part 58, 60 can be screwed onto the other housing part 58, 60. Alternatively or additionally thereto, the first housing part 58 and the second housing part 60 can be connected by a weld connection, a clip connection, and/or a crimped connection.

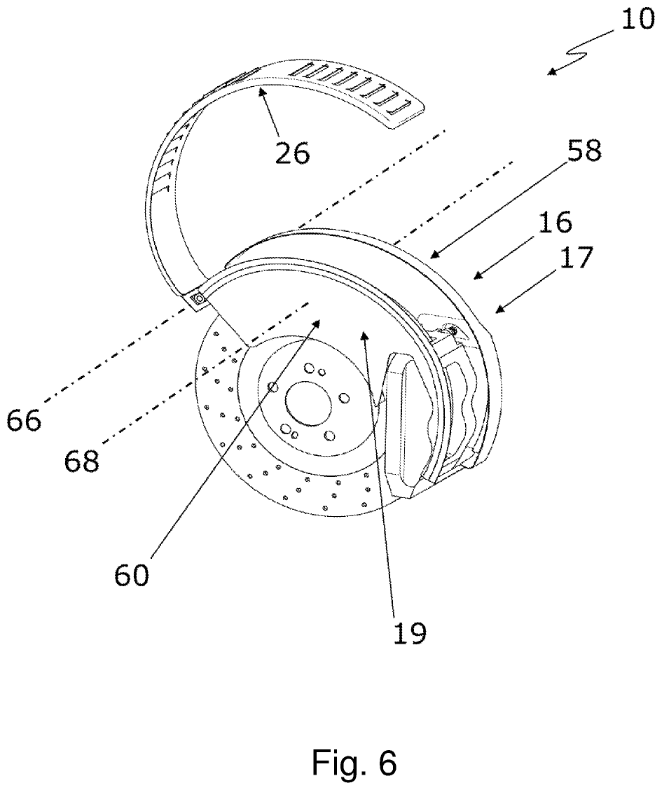

As illustrated in FIG. 6, in a fourth embodiment of the disc brake assembly 10, the first housing part 58 and the second housing part 60 can be connectable and/or are connected to each other by a pivot mechanism and/or a folding mechanism in order to be able to open and close again quickly the brake dust particle filter 16. The pivot axis 66 of the pivot mechanism can extend in this context parallel to an axis 68 which connects the two housing sidewalls 17, 19 or extends through them, and in this case extends additionally parallel to the axis of rotation of the brake disc. Then, the housing peripheral wall 26 can be pivoted relative to the two housing sidewalls 17, 19.

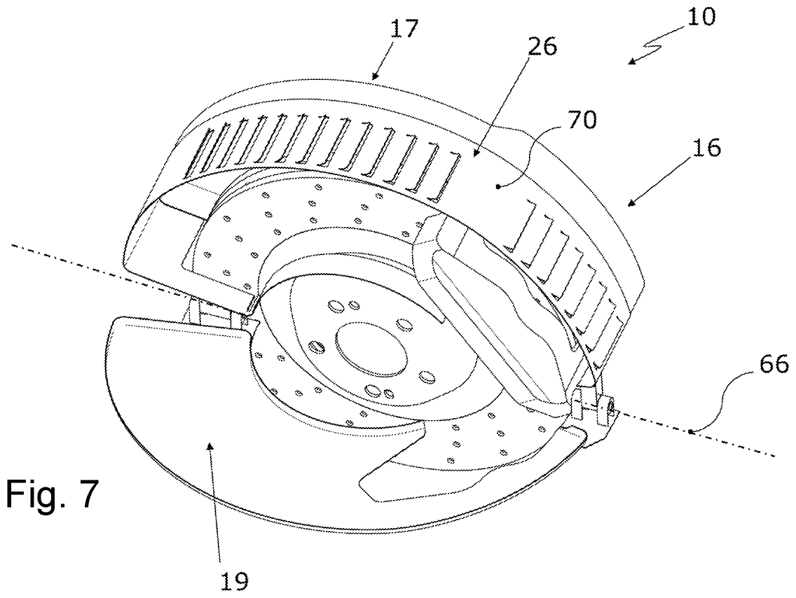

Alternatively or additionally thereto, in a fifth embodiment of the disc brake assembly 10, the pivot axis 66 of the pivot mechanism can extend perpendicular to the outer circumferential side 70 of the housing peripheral wall 26 of the brake dust particle filter 16 in the mounted state, as illustrated in FIG. 7. Then, the first housing sidewall 17 can be pivoted relative to the second housing sidewall 19 and the housing peripheral wall 26.

When reviewing all Figures of the drawing, the invention in summary concerns a brake dust particle filter 16 for a disc brake assembly 10 with a brake disc 12 and a caliper 14. In the housing interior 20 of the housing 18 of the brake dust particle filter 16, at least one tongue 28a-28d is arranged or embodied wherein at least a section of this tongue 28a-28d projects radially inwardly. The tongue 28a-28d forms a support 40 for a filter medium 32 of the brake dust particle filter 16. Moreover, the filter medium 32 covers the surface of the tongue 28a-28d at least partially, in particular completely. The housing 18 has the shape of a ring segment. It can be used to accommodate at least partially the brake disc 12 in the housing interior 20. A first housing sidewall 17 and a second housing sidewall 19 as well as a housing peripheral wall 26, 62, 64 each form parts of the housing 18. The housing sidewalls 17, 19 are spaced apart from each other in axial direction. The housing peripheral wall 26, 62, 64 is arranged radially outwardly in the circumferential direction of the housing 18. The housing peripheral wall 26, 62, 64 is arranged or embodied between the first housing sidewall 17 and the second housing sidewall 19. The brake dust particle filter 16 is configured for catching particles that are produced when braking.

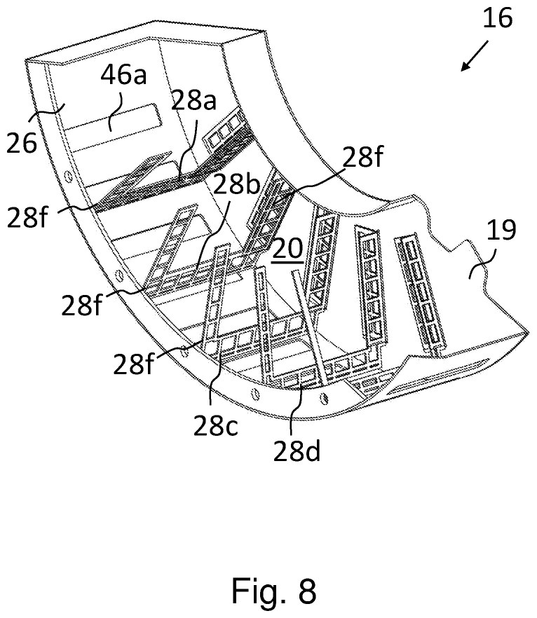

In FIG. 8, finally a further embodiment of the brake dust particle filter 16 is illustrated which comprises in its housing interior 20 the afore described tongues 28a-28d spaced apart from each other in circumferential direction which project from the housing peripheral wall 26 as well as additional tongues 28f which project from a housing sidewall 19. The tongues 28a-28f are embodied such that “lateral tongues” 28f and “circumferential tongues” 28a-28d that are located at a common circumferential angle form a continuous tongue, respectively. The resulting continuous tongue has in this context a substantially U-shaped basic form. In order to be able to better recognize the structure of the tongues 28a-28f, the filter medium is not shown in the isometric view. The tongues 28a-28f have each a plurality of through openings through which the air to be filtered which is laden with brake dust can be guided while passing through the filter medium. Due to the combination of the “circumferential tongues” with the “lateral tongues”, the separation performance can be further improved. The tongues 28a-28f in the illustrated embodiment are made of a mesh material, preferably a metal mesh, which comprises the through openings already as raw material, which simplifies manufacture.

What is claimed is:

1. A brake dust particle filter for a disc brake assembly with a brake disc and a brake caliper, wherein the brake dust particle filter is configured for catching particles produced when braking, the brake dust particle filter comprising:
a ring segment-shaped housing comprising a housing interior and configured to at least partially accommodate the brake disc in the housing interior;
the ring segment-shaped housing comprising housing walls, including two housing sidewalls that are axially spaced apart from each other and further including a housing peripheral wall extending radially outwardly in a circumferential direction of the ring segment-shaped housing, wherein the housing peripheral wall is arranged between the two housing sidewalls;
at least one first tongue arranged in the housing interior and projecting at least in sections with at least one radial component from the housing peripheral wall inwardly, wherein the at least one first tongue comprises a flat cross-sectional shape and comprises at least one base surface facing the housing peripheral wall, a cover surface projecting into the housing interior, and at least one side surface;
at least one filter medium;
wherein the at least one first tongue supports the at least one filter medium and is covered at least at the at least one side surface with the at least one filter medium.

2. The brake dust particle filter according to claim 1, wherein the flat cross-sectional shape of the at least one first tongue has a substantially rectangular cross section with a wide side and a narrow side, wherein a ratio of the wide side to the narrow side is between 15 and 60.

3. The brake dust particle filter according to claim 1, wherein the at least one first tongue is arranged or embodied at one of the housing walls such that the at least one filter medium is connected indirectly or directly to said housing wall.

4. The brake dust particle filter according to claim 1, further comprising a filter element with a filter element support structure, wherein the filter element includes the least one filter medium, wherein the filter element support structure includes the at least one first tongue, and wherein the filter element is arranged in the ring segment-shaped housing.

5. The brake dust particle filter according to claim 4, wherein the at least one filter medium is fastened to one or more elements selected from the group consisting of the at least one first tongue; the housing walls; and the filter element support structure.

6. The brake dust particle filter according to claim 1, further comprising at least one second tongue projecting into the housing interior from at least one the two housing sidewalls.

7. The brake dust particle filter according to claim 6, wherein the at least one first tongue and the at least one second tongue form a continuous tongue which has an L-shaped or U-shaped basic form.

8. The brake dust particle filter according to claim 1, wherein the at least one filter medium forms a fold into which the at least one first tongue projects at least partially.

9. The brake dust particle filter according to claim 1, wherein the at least one first tongue comprises one or more through openings covered by the at least one filter medium.

10. The brake dust particle filter according to claim 1, wherein the at least one filter medium in a region of the at least one first tongue forms a catching pocket for particles, wherein the catching pocket in a mounted state of the brake dust particle filter is closed in a downward direction to prevent escape of the particles due to gravity acting on the particles.

11. The brake dust particle filter according to claim 1, wherein the at least one filter medium comprises a first region and a second region, wherein the first region is a first filter layer and the second region is a second filter layer, wherein the second filter layer comprises a larger porosity than the first filter layer, wherein the first filter layer is arranged between the second filter layer and the at least one first tongue.

12. The brake dust particle filter according to claim 1, further comprising an additional filter medium comprising a porosity that is larger than a porosity of the at least one filter medium, wherein the at least one filter medium is arranged as a first filter layer between the at least one first tongue and the additional filter medium forming a second filter layer.

13. The brake dust particle filter according to claim 1, wherein a plurality of the at least one first tongue project inwardly into the housing interior and are spaced apart from each other in the circumferential direction.

14. The brake dust particle filter according to claim 13, wherein two or more of the plurality of the first tongues are positioned at a different angle relative to the housing peripheral wall, respectively.

15. The brake dust particle filter according to claim 1, configured such that an increase of a filter action on air being moved by the brake disc in the circumferential direction of the ring segment-shaped housing is provided in the circumferential direction.

16. The brake dust particle filter according to claim 15, wherein the increase of the filter action is provided in that a porosity of the at least one filter medium decreases, beginning at a bearing region of the brake dust particle filter provided for bearing against the brake caliper, in the circumferential direction of the ring segment-shaped housing.

17. The brake dust particle filter according to claim 16, wherein a plurality of the at least one first tongue project inwardly into the housing interior and are spaced apart from each other in the circumferential direction, wherein the porosity of the at least one filter medium is larger at one of the plurality of the first tongues closer to the bearing region than at a neighboring one of the plurality of the first tongues farther removed from the bearing region.

18. The brake dust particle filter according to claim 15, wherein the increase of the filter action is provided in that a thickness of the at least one filter medium increases, beginning at a bearing region of the brake dust particle filter provided for bearing against the brake caliper, in the circumferential direction of the ring segment-shaped housing.

19. The brake dust particle filter according to claim 15, wherein the increase of the filter action is provided in that a plurality of the at least one first tongue project inwardly into the housing interior and are spaced apart from each other in the circumferential direction in a direction away from a bearing region of the brake dust particle filter provided for bearing against the brake caliper, wherein one of the plurality of the first tongues closer to the bearing region is positioned at a smaller angle relative to the housing peripheral wall than a neighboring one of the plurality of tongues farther removed from the bearing region.

20. The brake dust particle filter according to claim 15, wherein the increase of the filter action is provided in that a plurality of the at least one first tongue project inwardly into the housing interior and are spaced apart from each other in the circumferential direction in a direction away from a bearing region of the brake dust particle filter provided for bearing against the brake caliper, wherein one of the plurality of the first tongues closer to the bearing region comprises more and/or larger through openings than a neighboring one of the plurality of the first tongues farther removed from the bearing region.

21. The brake dust particle filter according to claim 15, wherein the increase of the filter action is provided in that a plurality of the at least one first tongue project inwardly into the housing interior and are spaced apart from each other in the circumferential direction in a direction away from a bearing region of the brake dust particle filter provided for bearing against the brake caliper, wherein a free end of one of the plurality of the first tongues projects less far radially inwardly into the housing interior of the ring segment-shaped housing than a free end of a neighboring one of the plurality of the first tongues farther removed from the bearing region.

22. The brake dust particle filter according to claim 15, wherein the increase of the filter action is provided in that a plurality of the at least one first tongue project inwardly into the housing interior and are spaced apart from each other in the circumferential direction in a direction away from a bearing region of the brake dust particle filter provided for bearing against the brake caliper, wherein a surface of one of the plurality of first tongues closer to the bearing region is smaller than a surface of a neighboring one of the plurality of the first tongues farther removed from the bearing region.

23. The brake dust particle filter according to claim 1, further comprising one or more openings disposed in one of the housing walls and configured to discharge filtered air.

24. The brake dust particle filter according to claim 23, wherein the one or more openings are disposed in the housing peripheral wall.

25. The brake dust particle filter according to claim 1, further comprising a housing end region, viewed in the circumferential direction of the ring segment-shaped housing, configured to at least partially cover the brake caliper at an outer circumference thereof, wherein in the housing end region one or more openings configured to discharge filtered air are provided.

26. The brake dust particle filter according to claim 1, further comprising one or more outwardly projecting ribs arranged or embodied at one of the housing walls.

27. The brake dust particle filter according to claim 26, wherein said one of the housing walls is the housing peripheral wall, wherein the one or more outwardly projecting ribs each are arranged adjacent to an opening and cover the opening at least partially relative to a predetermined inflow direction of air.

28. The brake dust particle filter according to claim 1, wherein the at least one filter medium comprises at least one material selected from the group of a metal, a metal fiber nonwoven, glass, ceramic, and a high temperature-resistant plastic material, wherein the at least one filter medium is preferably still resistant at a temperature of more than 600° C.

29. The brake dust particle filter according to claim 28, wherein the high temperature-resistant plastic material is polyether ether ketone.

30. The brake dust particle filter according to claim 1, wherein the ring segment-shaped housing extends about a ring segment angle of at least 45°.

31. A disc brake assembly comprising a brake disc, a brake caliper, and a brake dust particle filter according to claim 1.

32. The disc brake assembly according to claim 31, wherein the brake dust particle filter is arranged stationarily relative to the brake caliper or is fastened to the brake caliper.

33. The disc brake assembly according to claim 31, further comprising a wheel bearing housing, wherein the brake dust particle filter is stationarily arranged relative to the wheel bearing housing or is fastened to the wheel bearing housing.

34. The disc brake assembly according to claim 31, further comprising a splash guard, wherein the brake dust particle filter is stationarily arranged relative to the splash guard; is fastened to the splash guard; or a first housing part of the ring segment-shaped housing forms the splash guard.

35. The disc brake assembly according to claim 31, wherein the brake dust particle filter adjoins flush the brake caliper in the circumferential direction of the ring segment-shaped housing.

36. The disc brake assembly according to claim 35, wherein the brake dust particle filter is arranged downstream of the brake caliper, viewed in a rotational direction of the brake disc for intended forward travel.

37. The disc brake assembly according to claim 31, wherein the brake dust particle filter covers an outer side of the brake caliper at least partially.

38. The disc brake assembly according to claim 37, wherein the ring segment-shaped housing of the brake dust particle filter comprises a housing end region, wherein the housing end region covers the outer side of the brake caliper, wherein the outer side of the brake caliper is a circumferential outer side.

39. The disc brake assembly according to claim 31, wherein the at least one first tongue of the brake dust particle filter comprises a free end oriented toward the brake caliper.

40. The disc brake assembly according to claim 39, wherein the brake dust particle filter comprises a plurality of the at least one first tongue, wherein the free ends of the plurality of the at least one first tongue are oriented toward the brake caliper.
